(19) United States
(12) Patent Application Publication
(10) Pub. No.: US 2011/0286054 A1
(43) Pub. Date: Nov. 24, 2011

(54) READING HEAD

(75) Inventors: Sueo Ueno, Shizuoka-ken (JP); Naoaki Ide, Shizuoka-ken (JP); Jun Sakakibara, Tokyo (JP); Katsuya Nagamochi, Tokyo (JP); Hiroyuki Shiraishi, Shizuoka-ken (JP); Yusuke Hashizume, Chiba-ken (JP); Kenji Itagaki, Shizuoka-ken (JP); Sasuke Endo, Kanagawa-ken (JP); Koji Shimokawa, Shizuoka-ken (JP); Naoya Koseki, Shizuoka-ken (JP); Mitsuru Hatano, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/110,707

(22) Filed: May 18, 2011

Related U.S. Application Data
(60) Provisional application No. 61/346,412, filed on May 19, 2010.
(60) Provisional application No. 61/346,377, filed on May 19, 2010.
(60) Provisional application No. 61/346,380, filed on May 19, 2010.
(60) Provisional application No. 61/346,382, filed on May 19, 2010.

(51) Int. Cl. H04N 1/04

(52) U.S. Cl. 358/475

(57) ABSTRACT

According to one embodiment, a reading head includes: a carriage configured to move in a sub-scanning direction with respect to a document table glass; a first light source provided to be movable integrally with the carriage and configured to illuminate a reading target position on the document table glass from an angle tilting to one side in the sub-scanning direction with respect to a reading optical axis extending in a normal direction in the reading target position on the document table glass; and a second light source provided to be movable integrally with the carriage and configured to illuminate the reading target position from a tilting angle larger than the angle of the first light source to the other side in the sub-scanning direction with respect to the reading optical axis and from a position further apart from the reading target position than the first light source.

### CROSS-REFERENCE TO RELATED APPLICATION(S)

This application is based upon and claims the benefit of priority from: U.S. provisional application 61/346,412, filed on May 19, 2010; U.S. provisional application 61/346,377, filed on May 19, 2010; U.S. provisional application 61/346,380, filed on May 19, 2010; and U.S. provisional application 61/346,382, filed on May 19, 2010; the entire contents all of which are incorporated herein by reference.

### FIELD

Embodiments described herein relate generally to an exposing technique in a reading head included in an image scanning apparatus.

### BACKGROUND

In the related art, there is known a reading head that illuminates an original document with two light sources arranged across a reading optical axis in a sub-scanning direction.

In the reading head in the related art, luminous intensity distribution optical axes of the respective light sources are arranged to coincide with the reading optical axis such that an amount of irradiated light in a position of the reading optical axis increases.

However, in the reading head in the related art, although a light amount distribution on the reading optical axis increases, light distribution is uneven around the reading optical axis in the sub-scanning direction. It is likely that a sufficient light amount is not obtained even in a position slightly shifted from the reading optical axis in the sub-scanning direction. Therefore, a work load is large, for example, strict assembly accuracy for performing accurate positioning with respect to the reading optical axis is requested.

### DESCRIPTION OF THE DRAWINGS

FIG. 1 is a schematic longitudinal sectional view of a configuration example of an image forming apparatus 1 in which a reading head 10 according to a first embodiment is mounted on a scanner;

FIG. 2 is a schematic longitudinal sectional view of the schematic configuration of the reading head 10 according to the first embodiment;

FIG. 3 is a diagram of the arrangement of light sources in the reading head 10 according to the first embodiment;

FIG. 4 is a diagram of the arrangement of light sources in a reading head according to a second embodiment;

FIG. 5 is a diagram of the schematic configuration of a reading head according to a third embodiment;

FIG. 6 is a diagram of luminous intensity distribution of a first light source 101c;

FIG. 7 is a diagram of luminous intensity distribution of a second light source 102c;

FIG. 8 is a diagram of luminous intensity distribution obtained by combining illumination lights irradiated by the first light source 101c;

FIG. 9 is a diagram of the schematic configuration of a reading head according to a fourth embodiment;

FIG. 10 is a diagram of luminous intensity distribution of a first light source 101d;

FIG. 11 is a diagram of luminous intensity distribution of a second light source 102d; and

FIG. 12 is a diagram of luminous intensity distribution obtained by combining illumination light irradiated by the first light source 101d and illumination light irradiated by the second light source 102d.

### DETAILED DESCRIPTION

In general, according to one embodiment, a reading head includes a carriage, a first light source, and a second light source.

The carriage moves in a sub-scanning direction with respect to a document table glass.

The first light source is provided to be movable integrally with the carriage and illuminates a reading target position on the document table glass from an angle tilting to one side in the sub-scanning direction with respect to a reading optical axis extending in a normal direction in the reading target position on the document table glass.

The second light source is provided to be movable integrally with the carriage and illuminates the reading target position on the document table glass from a tilting angle larger than the angle of the first light source to the other side in the sub-scanning direction with respect to the reading optical axis and from a position further apart from the reading target position than the first light source.

Embodiments are explained below with reference to the accompanying drawings.

### First Embodiment

First, a first embodiment is explained.

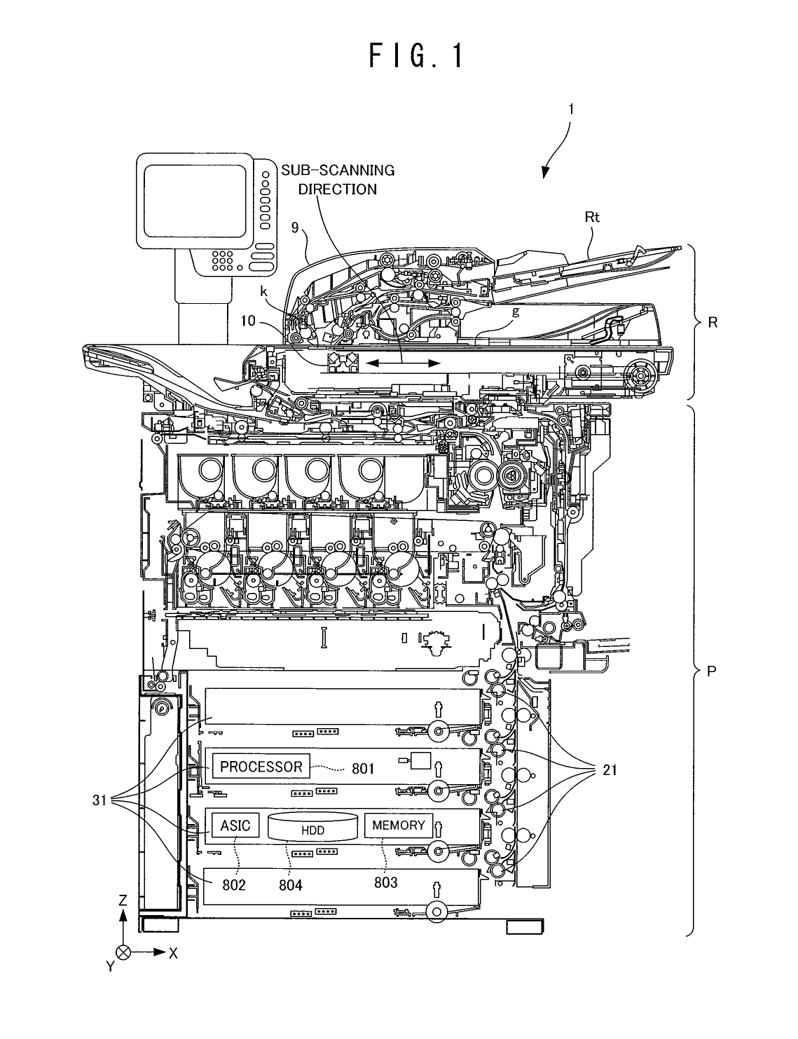

FIG. 1 is a schematic longitudinal sectional view of a configuration example of an image forming apparatus 1 in which a reading head 10 according to the first embodiment is mounted on a scanner.

The image forming apparatus 1 includes an image reading section R including an ADF 9 and the reading head 10 and an image forming section P configured to form an image on a sheet on the basis of acquired image data.

Original documents stacked on a document tray Rt included in the ADF 9 are sequentially conveyed to a reading position by the ADF 9.

The reading head 10 optically reads an image on a sheet conveyed to a predetermined reading position.

The reading head 10 scans an original document placed on a document table glass g while moving in a sub-scanning direction and reads an image of the original document.

The image forming section P conveys, with conveying sections 21 and the like, a sheet stored in paper feeding cassettes 31 and performs image formation processing based on image data.

The image forming apparatus 1 according to this embodiment includes a processor 801, an ASIC (Application Specific Integrated Circuit) 802, a memory 803, and a HDD (Hard Disk Drive) 804.

In the image forming apparatus 1 according to this embodiment, the processor 801 performs driving control for the reading head 10 and light emission control for light sources (control of light emission timing and a light amount, etc.) included in the reading head 10. The processor 801 has a role of realizing various functions by executing computer programs stored in the memory 803, the HDD 804, and the like. It goes without saying that the processor 801 can be realized by a CPU (Central Processing Unit) or an MPU (Micro Processing Unit) that can execute equivalent arithmetic processing. Similarly, the HDD 804 can be substituted by a storage device such as a flash memory.

The memory 803 can include, for example, a RAM (Random Access Memory), a ROM (Read Only Memory), a DRAM (Dynamic Random Access Memory), an SRAM (Static Random Access Memory), a VRAM (Video RAM), or a flash memory. The memory 803 has a role of storing various kinds of information and computer programs used in the image forming apparatus 1.

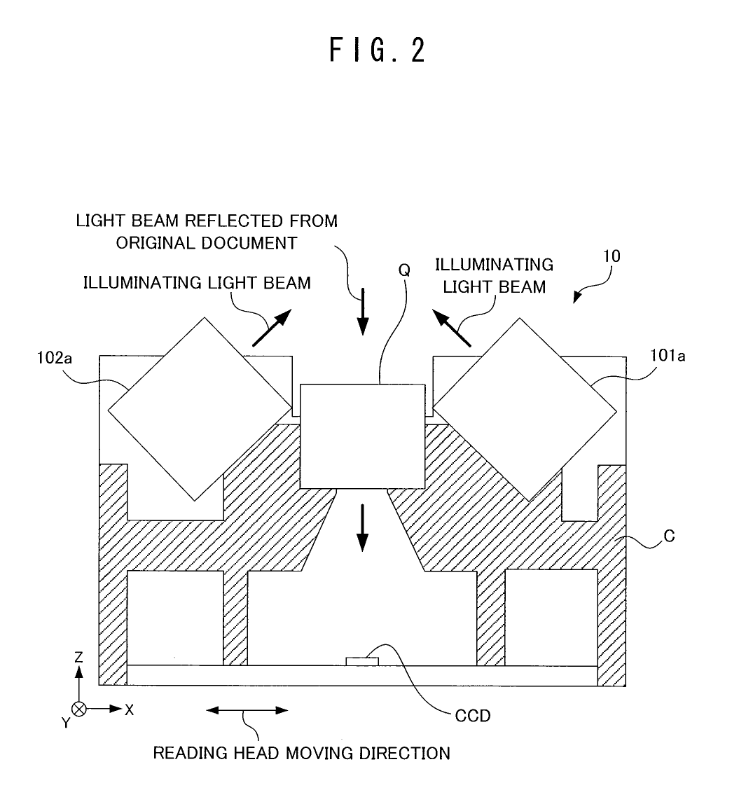

FIG. 2 is a schematic longitudinal sectional view of the schematic configuration of the reading head 10 according to the first embodiment.

The reading head 10 is, for example, a contact image sensor and includes first and second light sources 101a and 102a configured to illuminate an original document, a CCD configured to receive reflected light from the original document, and a lens Q configured to guide the reflected light from the original document to the CCD.

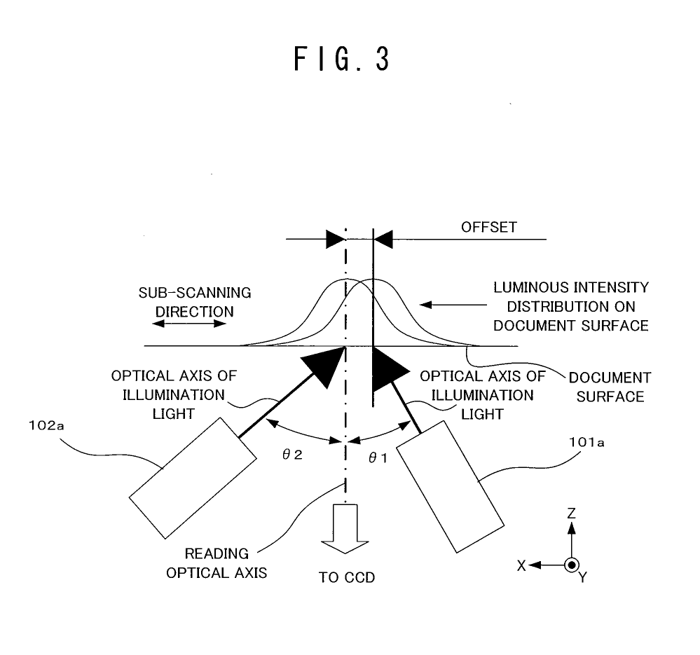

The arrangement of the light sources in the reading head 10 according to the first embodiment is explained in detail below with reference to FIG. 2 and FIG. 3.

The reading head 10 includes a carriage C, the lens Q, the first light source 101a, the second light source 102a, and the CCD.

The carriage C moves in the sub-scanning direction (a direction parallel to an X axis) with respect to the document table glass g.

The first light source 101a is provided to be movable integrally with the carriage C. The first light source 101a illuminates a reading target position on the document table glass g from an angle (θ1) tilting to one side in the sub-scanning direction with respect to a reading optical axis extending in a normal direction in the reading target position on the document table glass g.

The second light source 102a is provided to be movable integrally with the carriage C. The second light source 102a illuminates the reading target position on the document table glass g from a tilting angle (θ2) larger than the angle of the first light source 101a to the other side in the sub-scanning direction with respect to the reading optical axis and from a position further apart from the reading target position than the first light source 101a.

In this way, a luminous intensity distribution optical axis of one of the two light sources (light guide tubes) opposed to each other in the sub-scanning direction across the reading optical axis is tilted with respect to the reading optical axis and a luminous intensity distribution position is shifted in the sub-scanning direction.

Consequently, a light distribution of the entire reading head 10 expands in the sub-scanning direction. Even illumination light on a position slightly shifted from the reading optical axis can have a sufficient light amount. As a result, it is possible to provide a high-quality read image.

The document table glass g in this embodiment includes a bumping member k functioning as a reference member against which one end in the sub-scanning direction of an original document placed on the document table glass g as a reading target is bumped.

The first light source 101a is arranged on a side closer to the bumping member k than the second light source 102a in the sun-scanning direction.

Consequently, it is possible to prevent illumination light from the first light source 101a from being blocked by an edge of the bumping member k.

It is desirable that an optical axis of illumination light from the second light source 102a coincides with the reading target position.

Since the illumination light from the second light source 102a is apart from the reading target position, a light amount of the illumination light reaching the reading target position tends to be small. Therefore, the optical axis of the illumination light from the second light source 102a and the reading target position are aligned. This makes it possible to secure an illumination light amount in the reading target position.

An optical axis of illumination light from the first light source 101a may be set not to cross the reading optical axis.

In this way, the optical axis of the illumination light from the light source is set not to cross the reading optical axis. This makes it possible to prevent occurrence of a shadow in the reading target position.

The first and second light sources 101a and 102a include light guide tubes extending in a direction (a main scanning direction) parallel to the document table glass g and orthogonal to the sub-scanning direction. In FIG. 3, for convenience of explanation, as the first and second light sources, sections of the light guide tubes respectively included in the light sources are shown.

### Second Embodiment

A second embodiment is explained below.

The second embodiment is a modification of the first embodiment. In the following explanation, components having functions same as the functions of the components already explained in the first embodiment are denoted by the same reference numerals and signs and explanation of the components is omitted.

A reading head according to the second embodiment includes a first light source 101b and a second light source 102b instead of the first light source 101a and the second light source 102a in the first embodiment.

The first light source 101b is provided to be movable integrally with the carriage C. The first light source 101b illuminates a position different from the reading target position on the document table glass g from an angle (θ1) tilting to one side in the sub-scanning direction with respect to the reading optical axis extending in the normal direction in the reading target position on the document table glass g.

The second light source 102b is provided to be movable integrally with the carriage C. The second light source 102b illuminates a position different from the reading target position on the document table glass g from an angle (θ2) tilting to the other side in the sub-scanning direction with respect to the reading optical axis.

Consequently, the light distribution of the entire reading head 10 expands in the sub-scanning direction. Even illumination light on a position slightly shifted from the reading optical axis can have a sufficient light amount (secure a light amount margin). As a result, it is possible to provide a high-quality read image.

In this embodiment, optical axes of lights respectively irradiated from the first and second light sources 101b and 102b do not cross the reading optical axis.

In this way, the configuration in which the first and second light sources 101b and 102b are arranged to be shifted in directions in which the first and second light sources 101b and 102b are apart from each other is adopted. This makes it easy to arrange the first and second light sources 101b and 102b in the carriage C.

The optical axes of the lights respectively irradiated from the first and second light sources 101b and 102b may be set not to cross the reading optical axis. In this way, the optical axes of the illumination lights from the light sources are set not to cross the reading optical axis. This makes it possible to prevent occurrence of a shadow in the reading target position.

The optical axes of the lights respectively irradiated from the first and second light sources 101b and 102b may be set to cross the reading optical axis.

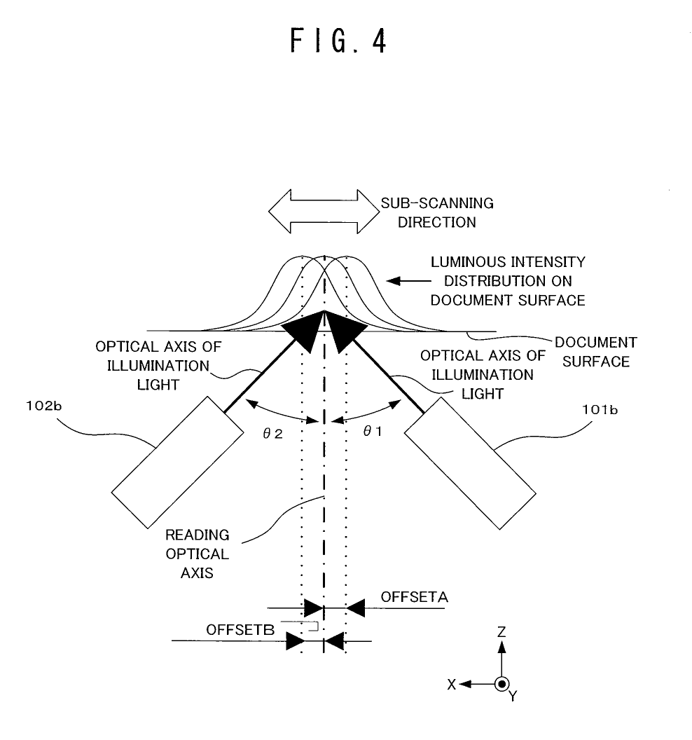

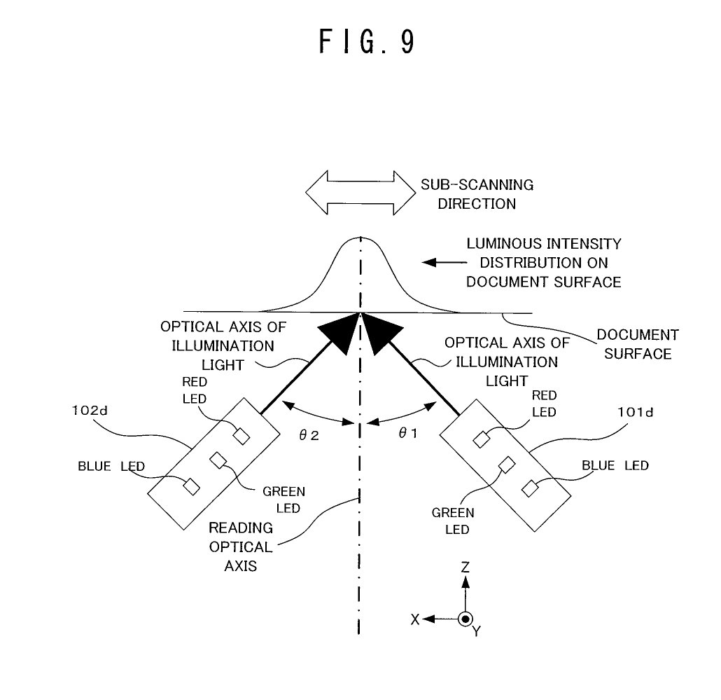

The first and second light sources 101b and 102b include light guide tubes extending in a direction (a main scanning direction) parallel to the document table glass g and orthogonal to the sub-scanning direction. In FIG. 4, for convenience of explanation, as the first and second light sources, sections of the light guide tubes respectively included in the light sources are shown (concerning a detailed configuration, see FIG. 9, etc.).

According to the second embodiment, it is possible to provide, for example, techniques explained in (1) to (4) below.

(1) A reading head including:

a carriage configured to move in a sub-scanning direction with respect to a document table glass;

a first light source provided to be movable integrally with the carriage and configured to illuminate a position different from a reading target position on the document table glass from an angle tilting to one side in the sub-scanning direction with respect to a reading optical axis extending in a normal direction in the reading target position on the document table glass; and

a second light source provided to be movable integrally with the carriage and configured to illuminate a position different from the reading target position on the document table glass from an angle tilting to the other side in the sub-scanning direction with respect to the reading optical axis.

(2) The reading head of (1), wherein optical axes of lights respectively irradiated from the first and second light sources do not cross the reading optical axis.
(3) The reading head of (1) or (2), wherein optical axes of lights respectively irradiated from the first and second light sources cross the reading optical axis.
(4) The reading head of any one of (1) to (3), wherein the light sources include light guide tubes extending in a direction parallel to the document table glass and orthogonal to the sub-scanning direction.

### Third Embodiment

A third embodiment is explained below.

The third embodiment is a modification of the embodiments explained above. In the following explanation, components having functions same as the functions of the components already explained in the embodiments are denoted by the same reference numerals and signs and explanation of the components is omitted.

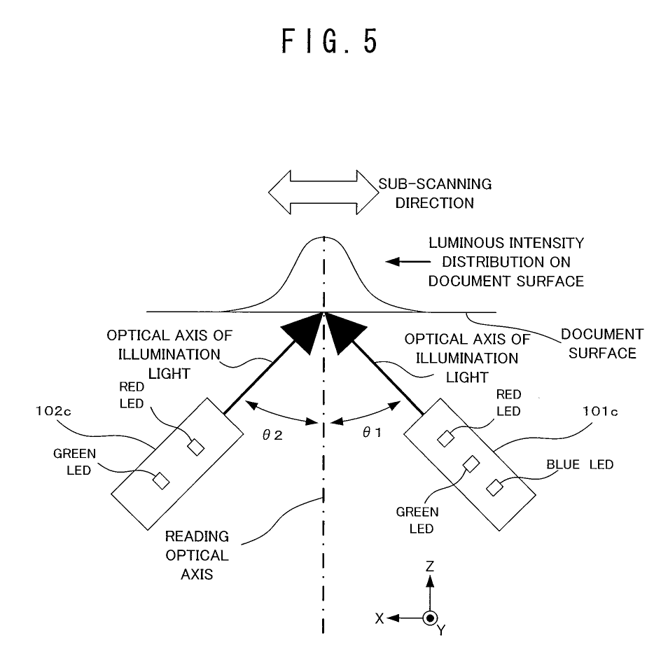

FIG. 5 is a diagram of the schematic configuration of a reading head according to the third embodiment.

The reading head according to the third embodiment includes the carriage C, a first light source 101c, and a second light source 102c.

In this embodiment, luminous intensity distributions substituting LEDs of Yellow-Green are generated by luminous intensity distributions of LEDs of RGB. Light guide tubes are used instead of LED arrays of Yellow-Green.

The first light source 101c includes LEDs for three colors of red, green, and blue and a light guide tube for guiding illumination lights from the LEDs for the three colors of red, green, and blue to a reading target region.

The second light source 102c includes LEDs for two colors of red and green and a light guide tube for guiding illumination lights from the LEDs for the two colors of red and green to the reading target region.

Specifically, in the first light source 101c, as ratios of spectral distributions, with green set as a reference, a ratio of the luminous intensity distribution of the LED for red is G×XR, a ratio of the luminous intensity distribution of the LED for green is G, and a ratio of the luminous intensity distribution of the LED for blue is G×XB.

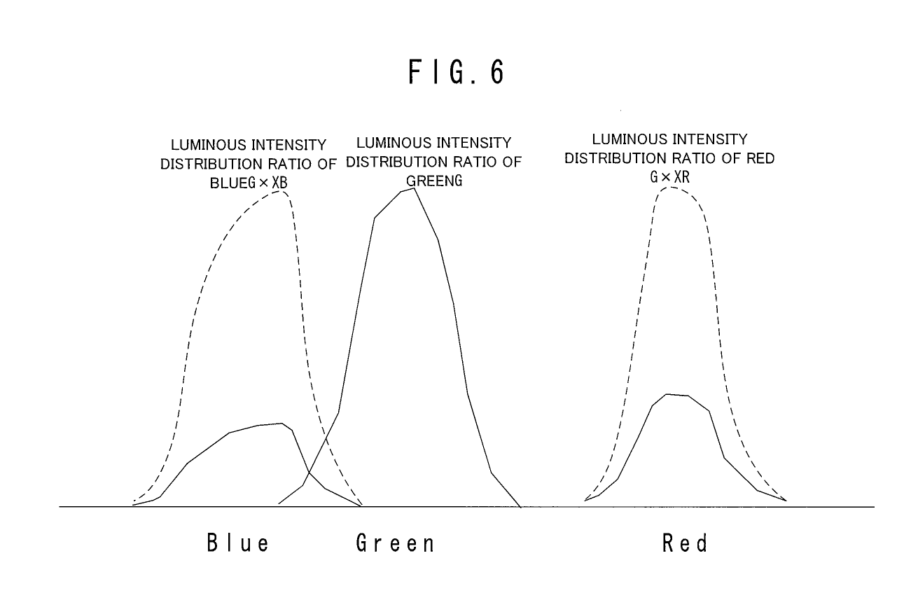

The coefficient XB is equal to or smaller than “0.25” and the coefficient XR is equal to or smaller than “0.3”. FIG. 6 is a diagram of the luminous intensity distribution of the first light source 101c.

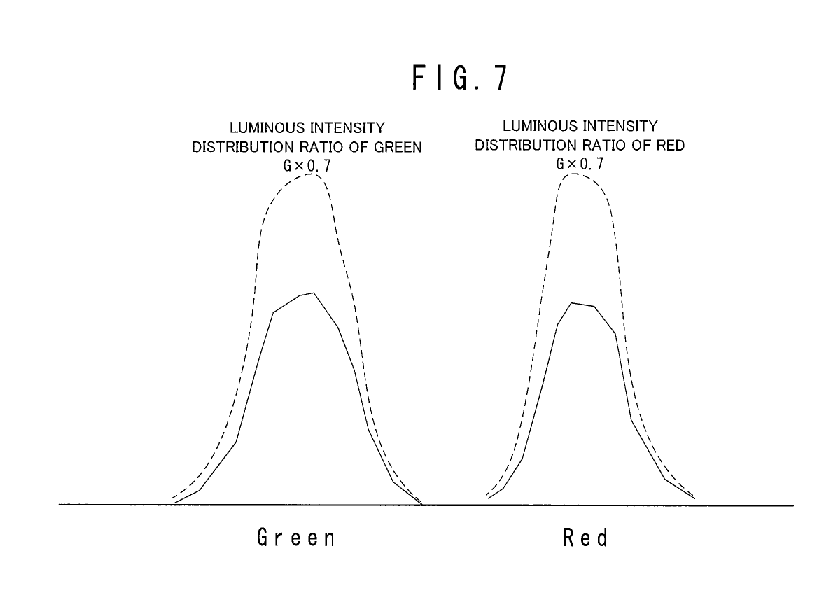

In the second light source 102c, as ratios of spectral distributions, with green set as a reference, a ratio of the luminous intensity distribution of the LED for red is G×0.7 and a ratio of the luminous intensity distribution of the LED for green is G×0.7. FIG. 7 is a diagram of the luminous intensity distribution of the second light source 102c.

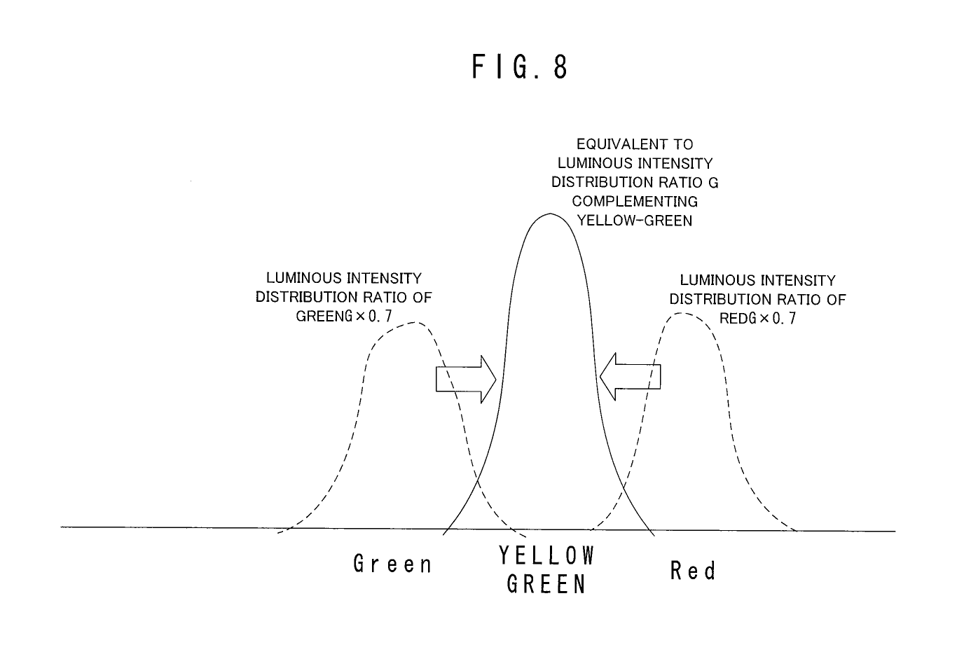

FIG. 8 is a diagram of luminous intensity distribution obtained by combining illumination lights irradiated by the first light source 101c having the luminous intensity distribution explained above (Yellow-Green complementation).

According to such a configuration, compared with the configuration in the related art in which the LED array in which LEDs for Yellow-Green are arrayed in the main scanning direction and the light source for distributing lights of the three kinds of LEDs for RGB in the main scanning direction with the light guide tube are arranged across the reading optical axis in the sub-scanning direction, a ripple due to the LED array for Yellow-Green is not caused and a ripple due to luminous intensity distribution can be eliminated. As a result, it is possible to provide high-quality image reading.

According to the third embodiment, it is possible to provide, for example, techniques explained in (1) and (2) below.

(1) A reading head including:

a carriage configured to move in a sub-scanning direction with respect to a document table glass;

a first light source provided to be movable integrally with the carriage and configured to illuminate, with three kinds of LEDs for red, green, and blue, a reading target position on the document table glass from an angle tilting to one side in the sub-scanning direction with respect to a reading optical axis extending in a normal direction in the reading target position on the document table glass; and

a second light source provided to be movable integrally with the carriage and configured to illuminate, in a state in which a spectral balance of two kinds of LEDs for red and green is set to a spectral characteristic for complementing LEDs for Yellow-Green and set to a luminous intensity distribution balance lower than that of the LEDs in the first light source, the reading target position on the document table glass from an angle tilting to the other side in the sub-scanning direction with respect to the reading optical axis.

(2) The reading head of (1), wherein the first and second light sources include light guide tubes extending in a direction parallel to the document table glass and orthogonal to the sub-scanning direction, and lights irradiated from the LEDs are guided to the reading target position by the light guide tubes.

### Fourth Embodiment

A fourth embodiment is explained below.

The fourth embodiment is a modification of the embodiments explained above. In the following explanation, components having functions same as the functions of the components already explained in the embodiments are denoted by the same reference numerals and signs and explanation of the components is omitted.

FIG. 9 is a diagram of the schematic configuration of a reading head according to the fourth embodiment.

The reading head according to the fourth embodiment includes the carriage C, a first light source 101d, and a second light source 102d.

In this embodiment, luminous intensity distributions substituting LEDs of Yellow-Green are generated by luminous intensity distributions of LEDs of RGB. Light guide tubes are used instead of LED arrays of Yellow-Green.

The first light source 101d includes LEDs for three colors of red, green, and blue and a light guide tube for guiding illumination lights from the LEDs for the three colors of red, green, and blue to a reading target region.

The second light source 102d includes LEDs for three colors of red, green, and blue and a light guide tube for guiding illumination lights from the LEDs for the three colors of red, green, and blue to the reading target region.

Specifically, in the first light source 101d, as ratios of spectral distributions, with green set as a reference, a ratio of the luminous intensity distribution of the LED for red is G×XR, a ratio of the luminous intensity distribution of the LED for green is G, and a ratio of the luminous intensity distribution of the LED for blue is G×XB.

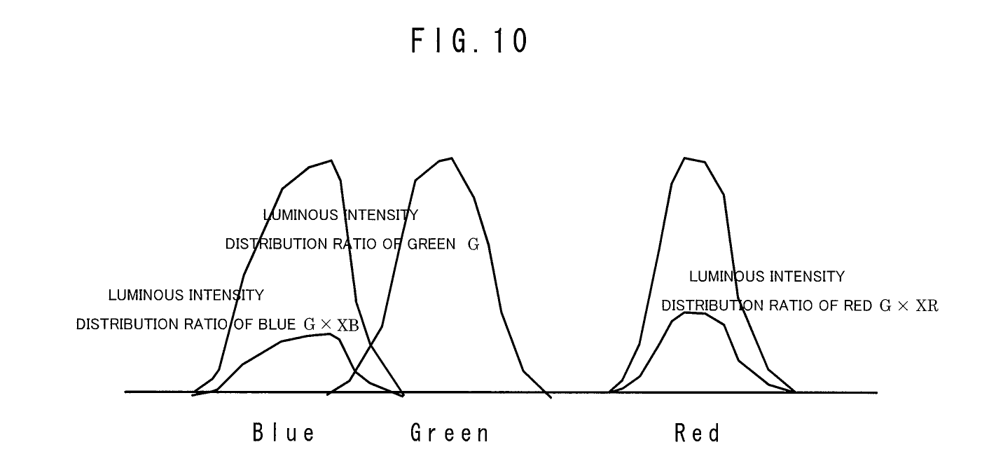

The coefficient XB is equal to or smaller than “0.25” and the coefficient XR is equal to or smaller than “0.3”. FIG. 10 is a diagram of the luminous intensity distribution of the first light source 101d.

In the second light source 102d, the luminous intensity distribution of the LED for red is G×XR, the luminous intensity distribution of the LED for green is G, and the luminous intensity distribution of the LED for blue is G×XB.

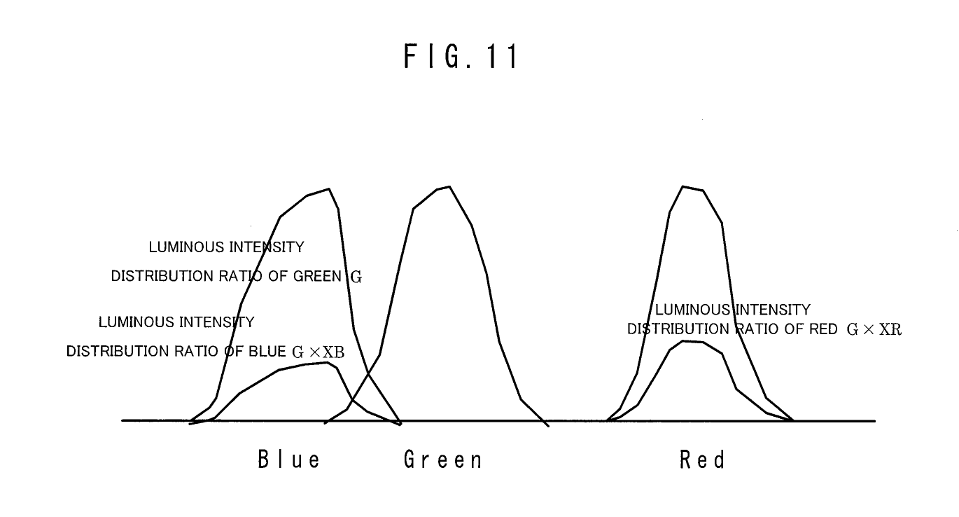

The coefficient XB is equal to or smaller than “0.25” and the coefficient XR is equal to or smaller than “0.3”. FIG. 11 is a diagram of the luminous intensity distribution of the second light source 102d.

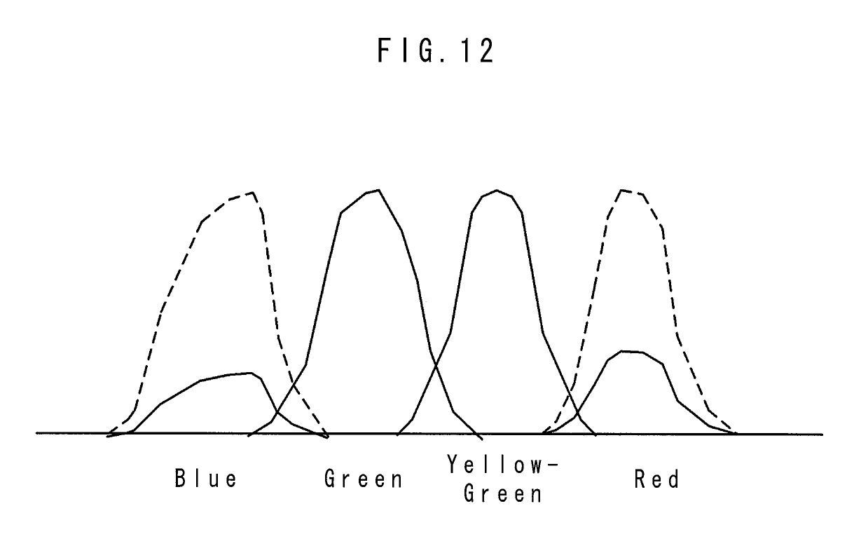

FIG. 12 is a diagram of luminous intensity distribution obtained by combining illumination light irradiated by the first light source 101d and illumination light irradiated by the second light source 102d having the luminous intensity distribution explained above.

According to such a configuration, compared with the configuration in the related art in which the LED array in which LEDs for Yellow-Green are arrayed in the main scanning direction and the light source for distributing lights of the three kinds of LEDs for RGB in the main scanning direction with the light guide tube are arranged across the reading optical axis in the sub-scanning direction, a ripple due to the LED array for Yellow-Green is not caused and a ripple due to luminous intensity distribution can be eliminated. As a result, it is possible to provide high-quality image reading.

According to the fourth embodiment, it is possible to provide, for example, techniques explained in (1) to (3) below.

(1) A reading head including:

a carriage configured to move in a sub-scanning direction with respect to a document table glass;

a first light source provided to be movable integrally with the carriage and configured to illuminate, in a state in which a spectral balance of three kinds of LEDs for red, green, and blue is set to a spectral characteristic for complementing LEDs for Yellow-Green, a reading target position on the document table glass from an angle tilting to one side in the sub-scanning direction with respect to a reading optical axis extending in a normal direction in the reading target position on the document table glass; and

a second light source provided to be movable integrally with the carriage and configured to illuminate, in a state in which a spectral balance of three kinds of LEDs for red, green, and blue is set to a spectral characteristic for complementing LEDs for Yellow-Green, the reading target position on the document table glass from an angle tilting to the other side in the sub-scanning direction with respect to the reading optical axis.

(2) The reading head of (1), wherein the spectral balance of the three kinds of LEDs for red, green, and blue in the first light source and the spectral balance of the three kinds of LEDs for red, green, and blue in the second light source are the same.
(3) The reading head of (1) or (2), wherein the first and second light sources include light guide tubes extending in a direction parallel to the document table glass and orthogonal to the sub-scanning direction, and lights irradiated from the LEDs are guided to the reading target position by the light guide tubes.

Further, a computer program for causing a computer included in the image forming apparatus 1 to execute the operations explained above can be provided as a reading head control program. In the examples explained in the embodiments, the computer program for realizing a function for carrying out the exemplary embodiments is stored in advance in a storage area provided on the inside of the apparatus. However, the same computer program may be downloaded from a network to the apparatus or the same computer program stored in a computer-readable recording medium may be installed in the apparatus. A form of the recording medium may be any form as long as the recording medium can store the computer program and can be read by the computer. Specifically, examples of the recording medium include an internal storage device internally mounted in a computer such as a ROM or a RAM, a portable storage medium such as a CD-ROM, a flexible disk, a DVD disk, a magneto-optical disk, or an IC card, a database that stores a computer program, other computers and databases of the computers, and a transmission medium on a line. A function obtained by installation or download in advance in this way may be realized in cooperation with an OS (operating system) on the inside of the apparatus.

The computer program may be an execution module dynamically generated partially or entirely.

It goes without saying that at least a part of various kinds of processing realized by causing the processor 801 to execute the computer program in the embodiments can also be executed by the ASIC 802 in a circuit manner.

As explained above in detail, according to the techniques described in this specification, it is possible to provide a reading head that has a wide light distribution in the sub-scanning direction and can provide a high-quality read image.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A reading head comprising:
a carriage configured to move in a sub-scanning direction with respect to a document table glass;
a first light source provided to be movable integrally with the carriage and configured to illuminate a reading target position on the document table glass from an angle tilting to one side in the sub-scanning direction with respect to a reading optical axis extending in a normal direction in the reading target position on the document table glass; and
a second light source provided to be movable integrally with the carriage and configured to illuminate the reading target position on the document table glass from a tilting angle larger than the angle of the first light source to the other side in the sub-scanning direction with respect to the reading optical axis and from a position further apart from the reading target position than the first light source.

2. The reading head according to claim 1, wherein
the document table glass includes a bumping member against which one end in the sub-scanning direction of an original document placed on the document table glass as a reading target is bumped, and
the first light source is arranged on a side closer to the bumping member than the second light source in the sub-scanning direction.

3. The reading head according to claim 1, wherein an optical axis of illumination light from the second light source coincides with the reading target position.

4. The reading head according to claim 1, wherein an optical axis of illumination light from the first light source does not cross the reading optical axis.

5. The reading head according to claim 1, wherein the first and second light sources include light guide tubes extending in a direction parallel to the document table glass and orthogonal to the sub-scanning direction.

6. A reading head comprising:
a carriage configured to move in a sub-scanning direction with respect to a document table glass;
a first light source provided to be movable integrally with the carriage and configured to illuminate a position different from a reading target position on the document table glass from an angle tilting to one side in the sub-scanning direction with respect to a reading optical axis extending in a normal direction in the reading target position on the document table glass; and
a second light source provided to be movable integrally with the carriage and configured to illuminate a position different from the reading target position on the document table glass from an angle tilting to the other side in the sub-scanning direction with respect to the reading optical axis.

7. The reading head according to claim 6, wherein optical axes of lights respectively irradiated from the first and second light sources do not cross the reading optical axis.

8. The reading head according to claim 6, wherein optical axes of lights respectively irradiated from the first and second light sources cross the reading optical axis.

9. The reading head according to claim 6, wherein the light sources include light guide tubes extending in a direction parallel to the document table glass and orthogonal to the sub-scanning direction.
